(19) United States
(12) Patent Application Publication
(10) Pub. No.: US 2016/0127458 A1
(43) Pub. Date: May 5, 2016

(54) P2P APPARATUS AND METHOD FOR P2P CONNECTION

(71) Applicants: ThroughTek Technology (ShenZhen) Co., Ltd., Shenzhen (CN); ThroughTek Co., Ltd., Taipei (TW)

(72) Inventor: Cheng-Wei LI, Taipei (TW)

(21) Appl. No.: 14/574,075

(22) Filed: Dec. 17, 2014

(30) Foreign Application Priority Data
Nov. 4, 2014 (TW) 103138183

(51) Int. Cl. H04L 29/08; H04L 29/06

(52) U.S. Cl. CPC H04L 67/104; H04L 69/16; H04L 67/141

(57) ABSTRACT

A point-to-point (P2P) apparatus has a device resource, a processor, a storage device and a network interface. The processor processes the device resource. The storage device stores a unique identification code. The network interface connects to a first network via a first gateway and transmits the unique identification code to a server via a second network by a first gateway. An external device accesses the device resource via the first gateway. The second network is a TCP/IP network and the first network is not a TCP/IP network.

### CROSS-REFERENCES TO RELATED APPLICATIONS

This non-provisional application claims priority under 35 U.S.C. §119(a) on Patent Application No. 103138183 filed in Taiwan, R.O.C. on 2014, Nov. 4, the entire contents of which are hereby incorporated by reference.

### FIELD OF THE INVENTION

The present invention relates to a point-to-point (P2P) apparatus and a P2P connection method and more particularly relates to a P2P apparatus and a P2P connection method via a gateway.

### BACKGROUND

Various electronic devices are developed for improving human life. Still, there are lots of technical problems to be solved to achieve more convenience and more application possibilities. Current network environment is usually composed of multiple homogenous or heterogeneous sub-networks. Specifically, the Internet serves as the main body and various gateways and routers are used for connecting private local networks, telecommunication networks. When two terminal devices want to be connected under a point-to-point connection, there are still many difficult technical problems to be solved. Things become particularly complicated when the two terminal devices are located in different sub-networks. For example, when terminal devices are located in different sub-networks behind different NAT (Network Address Translation) devices, these terminal devices may have different private network addresses. Besides, it is also challenging to find a better way to establish efficient network connection.

### SUMMARY OF THE INVENTION

According to an embodiment of the present invention, a point-to-point (P2P) apparatus includes a device resource, a processor, a storage and a network interface. The processor processes the device resource, e.g. to collect information of a heartbeat sensor. The device resource may refer to various bio-information sensors for collecting information like heartbeat, blood pressure and blood oxygen level. The storage is used for storing an unique identification code. The point-to-point apparatus connects to a gateway among multiple gateways via the network interface over a firs network. The term of gateway may refer to various electronic devices like a mobile phone, a tablet computer, a portable device like a watch, a router, a television box, or a computer. The first network may refer to a short range communication network like a Bluetooth, Zigbee, NFC, iBeacon wireless network or a USB wire network. Under different needs, a user may connect one point-to-point apparatus to different gateways at different times. For example, a point-to-point apparatus for detecting heartbeat may be connected to a computer as a gateway during office hours for a user. When the user goes home, the same point-to-point apparatus for detecting heartbeat may be connected to a television box at home.

Besides, the point-to-point apparatus submits the unique identification code to a server over a second network via the gateway. The second network may refer to any kind of wire or wireless networks. In addition, when the first network is a non-TCP/IP network, e.g. a Bluetooth network, and the second network is a TCP/IP network, the point-to-point apparatus may connect to the TCP/IP network via the gateway to further connect to a local TCP/IP network or the Internet. Such configuration makes a point-to-point apparatus with only Bluetooth connectivity to extend connectivity to the Internet indirectly.

Because each point-to-point apparatus has its own unique identification code and each point-to-point apparatus registers its unique identification code on the server via an associated gateway, the server knows which gateway serving the point-to-point apparatus and how to connect to the gateway.

Therefore, the external device may query the unique identification code to the server to find out the associated gateway currently corresponding to the point-to-point apparatus to use the gateway to access the device resource. For example, a user may use a mobile phone via a television box as a gateway that connects to the Internet to access heartbeat information of his father with a heartbeat detector that has only Bluetooth connectivity.

In addition, after the external device retrieves the unique identification code and connection information of the gateway, the external device may establish point-to-point connection with the gateway to save complicated server establishment and maintenance cost and to avoid bottleneck problem.

In addition to the point-to-point apparatus, the gateway may have its own unique identification code that is also sent to the server to be registered to update most current status and new connection information.

If the point-to-point apparatus does not have proper operating interface, the first gateway may also provide an interface for a user to configure the point-to-point apparatus. Such interface may be used for the user to set the unique identification code of the point-to-point apparatus on the server.

According to another embodiment of the present invention, a method for P2P connecting includes following steps. A first process, e.g. a program, is provided to be installed in multiple gateways. An unique identification code is provided to be installed in a point-to-point apparatus that has a device resource. A server is also provided. When an external device requests to be connected to the point-to-point apparatus according to the unique identification code, the server finds out a first gateway connected to the point-to-point apparatus and assists establishing a point-to-point connection between the first gateway and the external device for the external device to access the device resource of the point-to-point apparatus. The first gateway is one of the multiple gateways and the point-to-point apparatus is selectively connected to the first gateway.

Under different needs, the server may be configured in different ways. For example, the server may include a main server and multiple point-to-point servers. The point-to-point apparatus periodically registers the unique identification code on the main server via the first gateway. The main server assigns a service point-to-point server selected from the multiple point-to-point servers. When the external device requests the server for accessing the point-to-point apparatus associated to the unique identification code, the main server informs the external device to request the assigned service point-to-point server and the assigned service point-to-point server assists the external device to establish a point-to-point connection with the first gateway.

This method also provides a second process to be installed in the point-to-point apparatus, e.g. a terminal device like a heartbeat detector, to process the communication to the server. The first process and the second process may be application programs, program modules, Apps or corresponding hardware logic circuits.

In addition, this method may further include providing an operating interface for a user to set the point-to-point apparatus. This method may also provide a second operating interface for the user to set the first gateway. This method may also include providing the unique identification code to the point-to-point apparatus.

With such design, various point-to-point apparatuses, even without capability of TCP/IP, may still connect to a TCP/IP network via gateways. In addition, even these point-to-point apparatuses are connected with different gateways, the external device may also find these point-to-point apparatuses according to their unique identification codes and thereafter access their device resources.

### BRIEF DESCRIPTION OF DRAWINGS

FIG. 1 illustrates an environment where an embodiment of the present invention is applied;

FIG. 2A illustrates a connection relation among a point-to-point apparatus, a gateway, a server and an external device;

FIG. 2B illustrates another relation among a point-to-point apparatus, a gateway, a server and an external device;

FIG. 3A illustrates a relation example among a point-to-point apparatus, a gateway and an external device;

FIG. 3B illustrates a relation example among a point-to-point apparatus, a gateway, a server and an external device;

FIG. 3C illustrates an example relation among a point-to-point device, a gateway, a main server, a point-to-point server and an external device;

FIG. 3D illustrates a connection example between two point-to-point devices via a gateway;

FIG. 4 illustrates a terminal device as an embodiment of the present invention;

FIG. 5 illustrates a software aspect for a terminal device according to an embodiment of the present invention;

FIG. 6 illustrates an example of a point-to-point apparatus according to the present invention; and

FIG. 7 illustrates a point-to-point connection method according the present invention.

### DETAILED DESCRIPTION

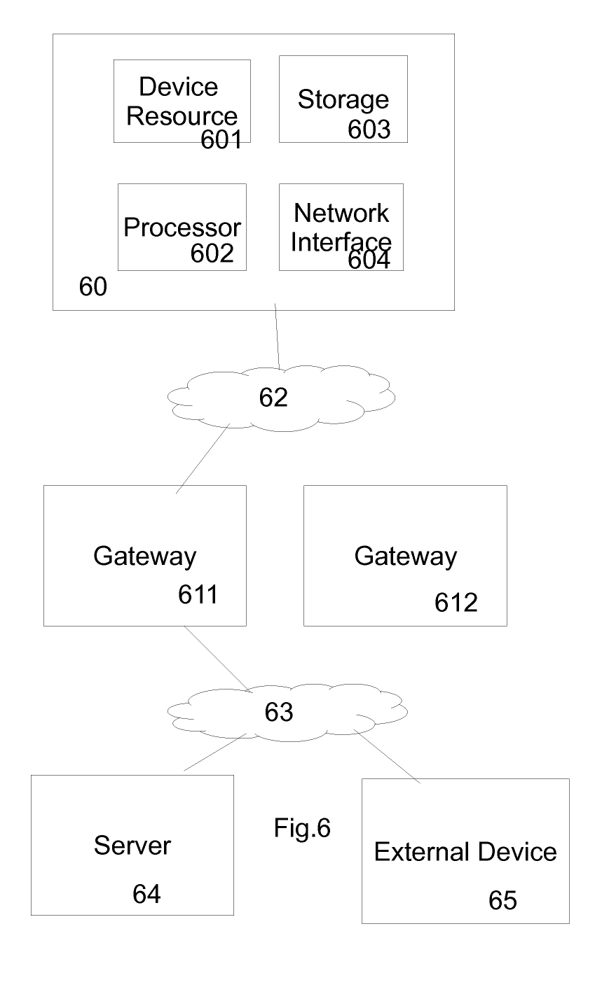

Please refer to FIG. 6.—According to an embodiment of the present invention, a point-to-point apparatus 60 includes a device resource 601, a processor 602, a storage 603 and a network interface 604. The processor 602 processes the device resource 601, e.g. for measuring heartbeat values of a heartbeat sensor. The device resource 601 may include various bio-information sensors for measuring heartbeat, blood pressure, blood oxygen or other information. The device resource 601 may be designed for measuring other information like an environment sensor for measuring temperature, moisture, fog level, etc. The point-to-point apparatus 60 may be any kind of home appliance or any kind of electronic devices, like a smart home appliance or a wearable device. The storage 603 is used for storing an unique identification code. The point-to-point apparatus 60 uses the network interface 604 connecting to one gateway 612 of multiple gateways 611, 612 over a first network 62. The gateway 611 may be any kind of electronic device like a mobile phone, a tablet computer, a smart watch, a router, a television box or a computer. The first network 62 may be a short range communication network like a Bluetooth, Zigbee, NFC, iBeacon wireless network or an USB wire network. 611, 612 ∘ Under different needs, a user may match one point-to-point apparatus 60 to multiple gateways 611, 612. For example, the point-to-point apparatus 60 for detecting heartbeat may be matched to a office computer as the gateway 611 during work hours. When the user goes home, the same point-to-point apparatus 60 for detecting heartbeat may be matched to a television box as the gateway 612.

In addition, the point-to-point apparatus 60 submits the unique identification code to a server 64 over a second network 63 via the gateway 611. The second network may be any kind of wire or wireless network. When the first network 62 may be a non-TCP/IP network like a Bluetooth network and the second network 63 is a TCP/IP network, the point-to-point apparatus 60 may connect to a TCP/IP network via the gateway 611 so as to further connect to a local TCP/IP network or the Internet. Therefore, such configuration enables a point-to-point apparatus that originally only has Bluetooth connectivity to connect to the Internet indirectly.

Because each point-to-point apparatus has its own unique identification code and the point-to-point apparatus registers the unique identification code on the server 64 via the gateway 611, the server 64 knows which gateway 611 is serving the point-to-point apparatus 60 and how to connect to the gateway 611.

Therefore, the external device 65 may query the server 64 with the unique identification code to find out the gateway 611 currently associated to the point-to-point apparatus 60 and further access the device resource 601 via the gateway 611. For example, a user may use a mobile phone connecting to a television box as the gateway 611 over the Internet to access heartbeat information of his father with a heartbeat detector that originally has Bluetooth connectivity.

In addition, the external device 65 may construct a point-to-point connection with the gateway 611 after receiving the unique identification code and the connection information of the gateway 611. Such scheme saves establishment cost of complicated servers and avoids unnecessary bottleneck problem.

In addition to the point-to-point apparatus 60, the gateway 611 may have an unique identification code and the gateway 611 may register its new status and updated connection information on the server 64.

If the point-to-point apparatus 60 does not have a proper operating interface, the first gateway 611 may provide an operating interface for a user to set the point-to-point apparatus 60. In addition, the operating interface may provide the user to set the unique identification code of the point-to-point apparatus 60 or other settings on the server 64. For example, such operating interface may use an App or a web interface to receive user input and communicate with the remote server 64 to show corresponding setting information.

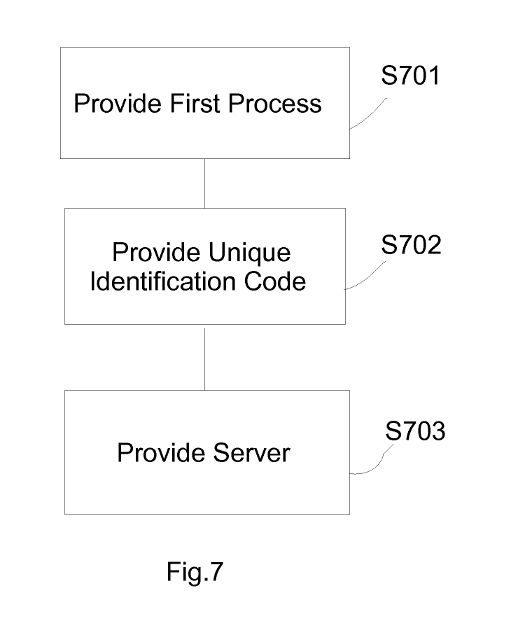

Please refer to FIG. 7, which is a flowchart of another embodiment. According to another embodiment of the present invention, a method for point-to-point connection includes following steps. A first process is provided to be installed on multiple gateways (step S701) for handling communication between the point-to-point apparatuses and the server. An unique identification code is provided (step S702) to be installed in a point-to-point apparatus that has a device resource. A server is provided (step S703). When an external device requests connection to the point-to-point apparatus with the unique identification code, the server finds a first gateway connecting to the point-to-point apparatus and assists the first gateway and the external device to perform a point-to-point connection between the first gateway and the point-to-point apparatus for the external device to access the device resource of the point-to-point apparatus. The first gateway is one of the multiple gateways. The point-to-point apparatus is selectively connected to the first gateway via a first network.

The server may have various configuration under different needs. For example, the server may include a main server and multiple point-to-point servers. When the point-to-point apparatus periodically registers the unique identification code on the main server, the main server assigns one service point-to-point server from the multiple point-to-point servers. When the external device requests the main server for accessing the point-to-point apparatus with the unique identification code, the main server informs the external device to requests service from the assigned service point-to-point server. The assigned service point-to-point server assists the external device to perform a point-to-point connection to the first gateway.

The method also provides a second process to be installed in the point-to-point apparatus for handling communication to the server or the gateway. For example, the second process is installed on a terminal device like a heartbeat detector point-to-point apparatus. The first process and the second process may be a corresponding application program, a program module, an App or corresponding hardware logic circuits.

In addition, the method may also provide an operating interface for a user to set the point-to-point apparatus. The method may also provide a second operating interface for the user to set the first gateway. The method may also include providing the unique identification code to the point-to-point apparatus.

Under such scheme, even a point-to-point apparatus having no TCP/IP connectivity may also connect to a TCP/IP network via a gateway. In addition, even these point-to-point apparatuses are connected to different gateways, the external device may also find these point-to-point apparatuses with their unique identification codes and access their device resources.

The first process, the second process and the operating interfaces may be implemented as Apps and located in an App store to be downloaded by a user. The first process may be implemented as a web page with corresponding Javascript codes or as other program format. The first process may be installed in the gateway in advance by manufacturers or installed by a user when the user wants to do so.

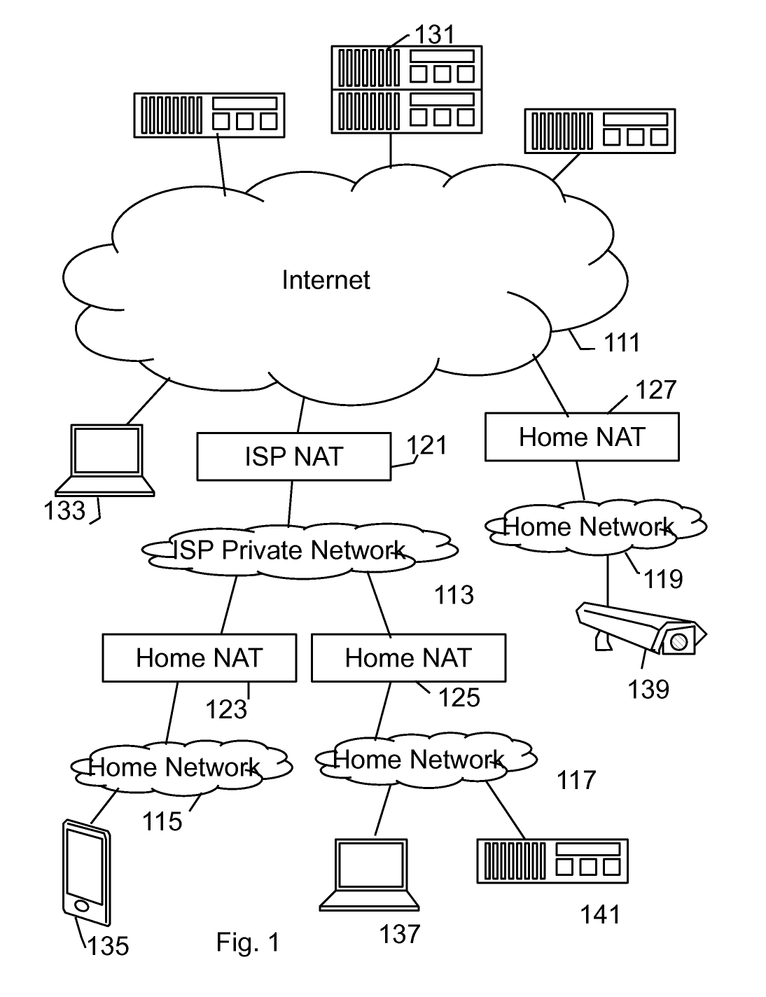

Please refer to FIG. 1, which illustrates different devices connected to a network. In this example, the network includes several sub-networks. For example, the server 131 or the computer 133 is assigned IPv4 or IPv6 addresses over the Internet 111. These devices may be accessed by other devices with corresponding unique IP addresses. In addition, various routers, gateways and other wire/wireless transmission channels are used for connecting devices, handling naming service, routing service and data transmission.

In addition to direct connection to the Internet 111, some devices are connected to the Internet 111 via an Internet Service Provider (ISP). Usually, an ISP provides NAT (Network Address Translation) devices to convert limited IPv4 or IPv6 addresses to private addresses of a private network of the ISP so that the devices in the private network 113 of the ISP may share these network resources. According to RFC 1918, three kinds of private addresses correspond to different number of private addresses. For example, 10.0.0.0-10.255.255.255 provide 16,777,216 private addresses, 172.16.0.0-17.31.255.255 provide 1,048,576 private addresses, and 192.168.0.0-192.168.255.255 provide 65,536 private addresses.

One private address may be assigned to different devices in different networks. Therefore, if only depending on these private addresses, the routers over the Internet 111 are not able to determine which devices are to be connected. If the computer 133 wants to access a device in a private network 113 of an ISP, the ISP provides a public address of its NAT to the computer 133. The NAT of the ISP finds which private address should be correspond to the address to transmit data.

There are various ways to implement NAT. In addition, in different network environments, NAT may have various nested combinations. For example, two home NAT 123 and 125 are located in a private network 113 of an ISP. The home NATs 123 and 125 respectively have their own home networks 115 and 117. Various terminal devices like a mobile phone 135, a computer 137 and a server 141 are connected to these home networks.

Because the home NAT 123 and the home NAT 125 are located in the private network 113 of the ISP, their IP addresses are private IP addresses like 192.168.1.131 provided by the NAT 121 of the ISP. If the computer wants to transmit data to the mobile phone 135, router or other devices, the public IP address of the NAT 121 of the ISP, the private IP address of the home NAT 123, and the private IP address of the mobile phone need to be found.

RFC1918 teaches how a device in a private network connects to the Internet 111, e.g. connecting to a Web server. Nevertheless, due to network complexity and various NAT designs, it is very complicated for two devices to perform point-to-point connection.

For example, if the mobile phone 135 wants to establish a point-to-point connection for connecting to an IP camera 139 in a home network 119 controlled by another NAT 127, the mobile phone 135 cannot access the IP camera 139 with its private address because the mobile phone 135 and the IP camera 139 are located in different private networks. In addition, due to the NAT 127, the mobile phone 135 cannot access the IP camera 139 with the public IP address of the NAT 127. In other network environments, there are firewalls or other network devices making point-to-point connection more complicated and difficult. In the following drawings and disclosures, several embodiments are provided for further explaining the present invention.

As mentioned above, most devices have TCP/IP network interfaces, e.g. Wi-Fi, RJ-45 or other communication interfaces. Nevertheless, due to cost or power consumption consideration, lots of devices do not have TCP/IP connectivity. For example, many heartbeat detectors, blood pressure detectors, EEG detector and other bio-information devices have short range network connectivity like Bluetooth or NFC, but may not have Wi-Fi connectivity. In such cases, mobile phones or other devices may be used as gateways as a bridge for connecting these point-to-point apparatuses to TCP/IP networks like the Internet.

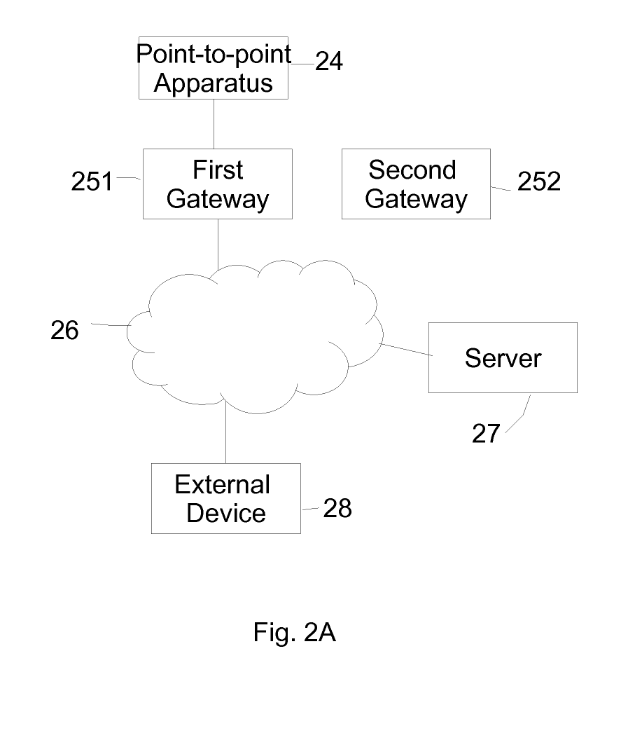

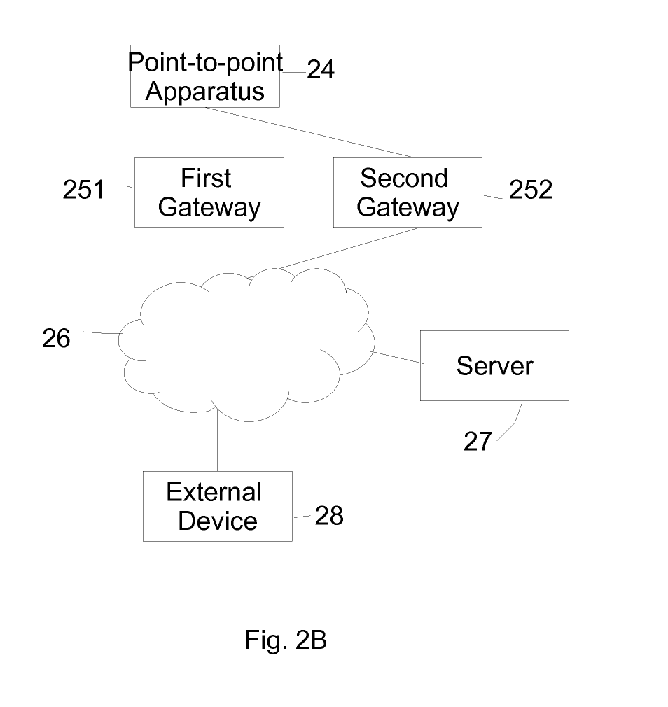

FIG. 2A and FIG. 2B respectively illustrate relation among the point-to-point apparatuses, the server and the external device. In FIG. 2A and FIG. 2B, each point-to-point device 24 is assigned an unique identification code for communicating with different gateways at different time. In FIG. 2A, the point-to-point apparatus 24 connects to a network 26 via the first gateway 251 and transmits the unique identification code of the point-to-point apparatus to the server 27 to register and to update. The external device 28 may request the server to perform a point-to-point connection to the point-to-point apparatus 24 with the unique identification code. The server 27 checks its records and knows that the point-to-point apparatus 24 is served by the first gateway 251, the server 27 assists the first gateway 251 to establish a point-to-point connection to the external device 28. As mentioned above, the first gateway 251 and the external device 28 may fall in different local networks or behind various firewalls. The server 27 may help relay connection parameters and use various hole-punching techniques to establish point-to-point connection between the first gateway 251 and the external device 28.

FIG. 2B illustrates pairing between the point-to-point apparatus 24 and the second gateway 252. For example, the point-to-point apparatus 24 is a Bluetooth heartbeat detector. When the user is working, the Bluetooth heartbeat detector is connected to the computer in the office and the computer is used as the first gateway 251. When the user brings the Bluetooth heartbeat detector and goes home, the Bluetooth heartbeat detector is paired with the television box at home and the television box at home is used as the second gateway 252.

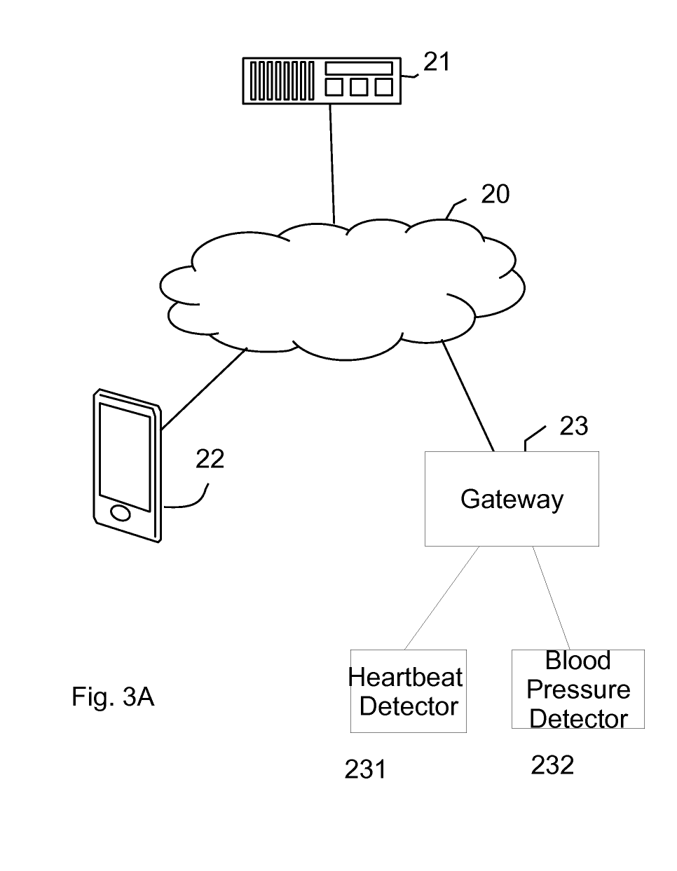

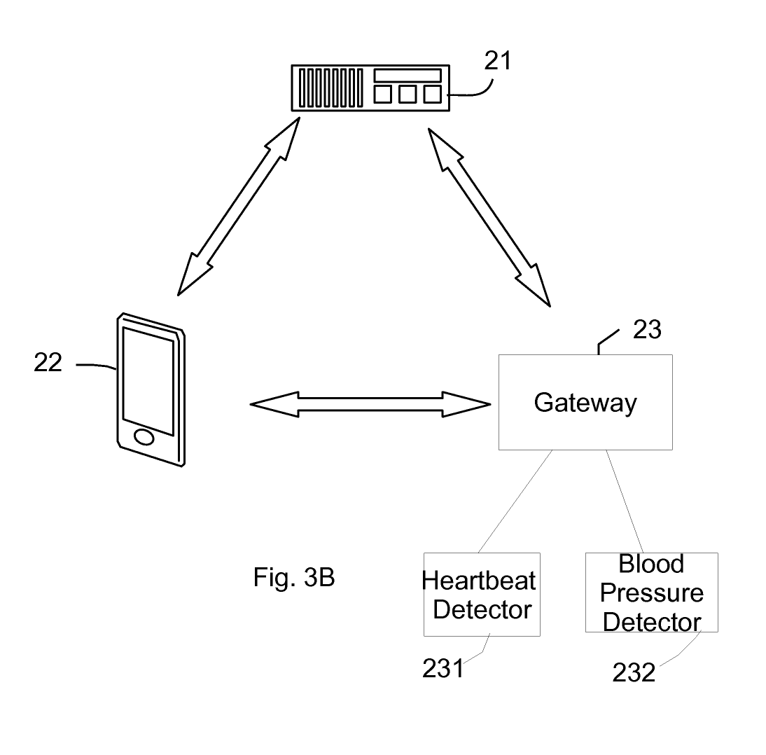

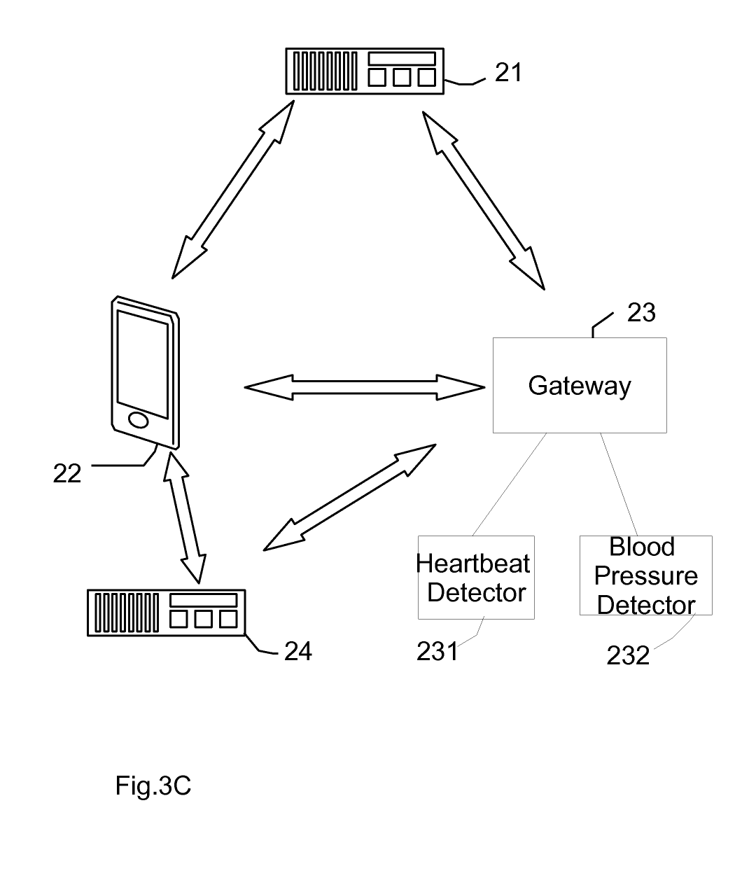

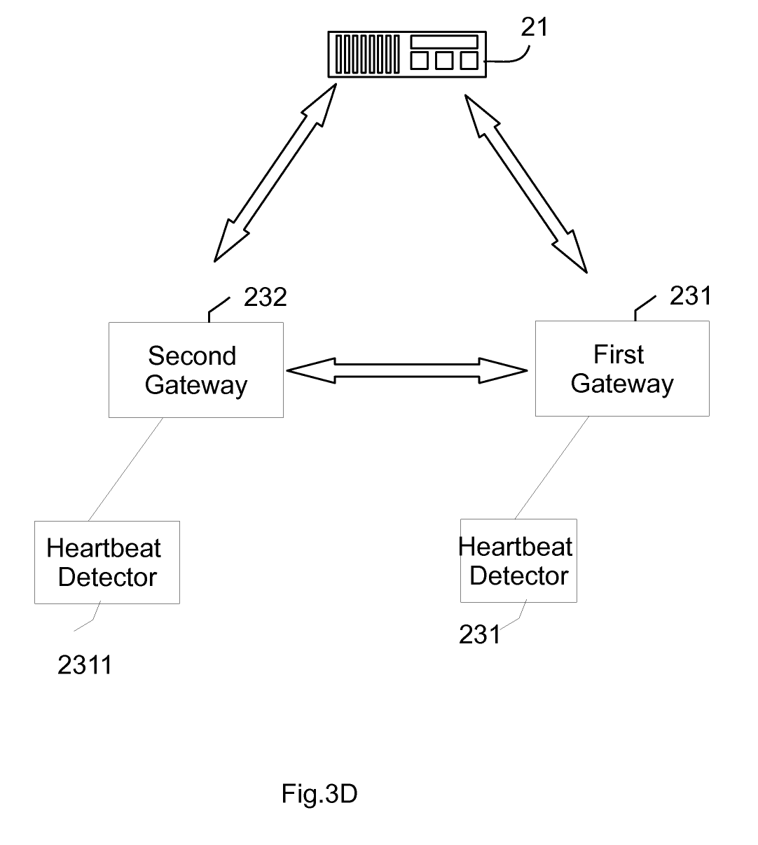

Please refer to FIG. 3A, which illustrates how a mobile phone 22 as an external device accesses the point-to-point apparatuses like a heat beat detector 231 and blood pressure detector 232. In this example, the heartbeat detector 231 and the blood pressure detector 232 do not have Wi-Fi connectivity but have Bluetooth transmission function. The heartbeat detector 231 and the blood pressure detector 232 use the Bluetooth transmission protocol to communicate with the gateway 23 and transmit their unique identification codes via the gateway 23 to the server 21. The network may refer to a single network or multiple networks like a combination of a local area network, a telecommunication network, and the Internet. The mobile phone 22 is used as an external device and requests the server for performing connection to the heartbeat detector 231 or the blood pressure detector 232 according to their unique identification codes. The server 21 provides the mobile phone 22 with related connection information of the gateway 23, like the network address and communication ports of the gateway 23. With such, the mobile phone 22 may perform a point-to-point connection to the gateway 23 to access information of the heartbeat detector 231 or the blood pressure detector 232.

FIG. 3B is related to FIG. 3A. The server 21 uses unique identification codes to identify and record information of the point-to-point apparatuses. The gateway 232 may have its own identification code and be accessed as another point-to-point apparatus. For example, the heartbeat detector 231 may be regarded as a peripheral device of the gateway 23, not an independent point-to-point apparatus. Under such configuration, the resource of unique identification codes may be saved. On the other hand, such configuration makes the heartbeat detector 231 needed to be tied to the specific gateway 23 and it is difficult to use the heartbeat detector 231 independently.

FIG. 3C is an alternative of FIG. 3B. In FIG. 3C, to avoid the server becoming a bottleneck, the server may include a main server 21 and one or more point-to-point servers 24. The mobile phone 22, the gateway 23, the heartbeat detector 231 and the blood pressure detector 232 respectively register on the main server 21 periodically. The term ‘periodically’ may refer to a predetermined schedule, but not be limited to fixed intervals. After the gateway 23, the heartbeat detector 231 and the blood pressure detector 232 register their unique identification codes on the main server 21, the main server 21 assigns a proper point-to-point server to serve these point-to-point apparatuses. When the mobile phone 22 sends request to the main server 21, the main server 21 checks the unique identification code in the connection request and finds the corresponding service point-to-point server. Next, the point-to-point server 24 serves the mobile phone 22 and corresponding point-to-point apparatuses like the heartbeat detector 231. Such scheme avoids bottleneck and prevents attack of hackers because hackers do not know which dynamic point-to-point server provides current service.

Unlike the above example, in FIG. 3D, the heartbeat detector 231 as the first point-to-point apparatus stores data in the heartbeat recorder 2311 as the second point-to-point apparatus. The heartbeat detector 231 and the heartbeat recorder 2311 are respectively served by the first gateway 231 and the second gateway 232. The first gateway 231 and the second gateway 232 are connected under a point-to-point connection with help of the server 21 to indirectly perform a point-to-point connection between the heartbeat detector 231 and the heartbeat recorder 2311.

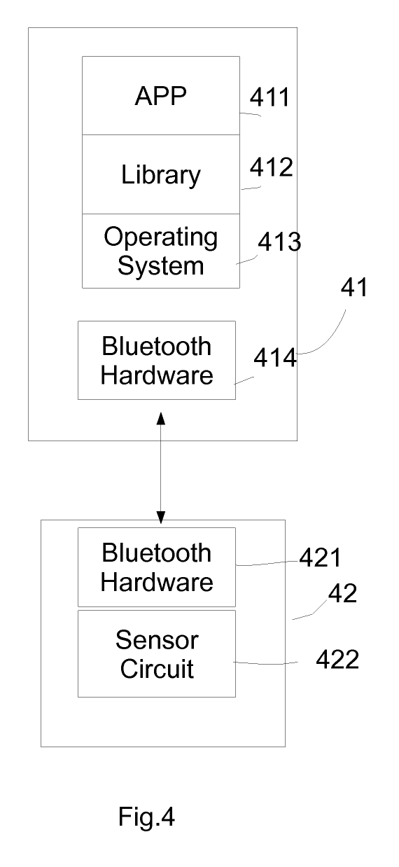

FIG. 4 illustrates relation between the point-to-point apparatus 42 and the gateway 41. In this example, the point-to-point apparatus 42 has a Bluetooth hardware 421 and a sensor circuit 422. The sensor circuit 422 records bio-information data and transmits the recorded data to the gateway 41 via the Bluetooth hardware 421. As mentioned above, the sensor circuit 422 includes a storage for storing the unique identification code. Even the point-to-point apparatus changes a gateway 41, the point-to-point apparatus may still keep persistent connection and perform information exchange.

The gateway 41 has a Bluetooth hardware 414. In software aspect, the gateway 41 has an operating system 413, a library 412 and an application App 411. The major logic for performing the point-to-point connection is constructed by the App 411, e.g. to transmit the unique identification code of the sensor circuit 422 to the server and to perform a point-to-point connection to an external device with help of the server. Besides, the gateway 41 may convert access instructions of an external device to a point-to-point instructions and transmit them to the point-to-point apparatus 42 with the Bluetooth hardware 414 and 421 to perform configuration or data request of the point-to-point apparatus 42. The library 412 may provide corresponding functions provided by unique identification code providers to simplify coding complexity of the App 411. Besides, corresponding tasks may be allocated in various ways between the point-to-point apparatus 42 and the gateway 41 under different needs. For example, in design with concern of power consumption, most computation may be performed by the gateway 41 to share loading of the point-to-point apparatus 42.

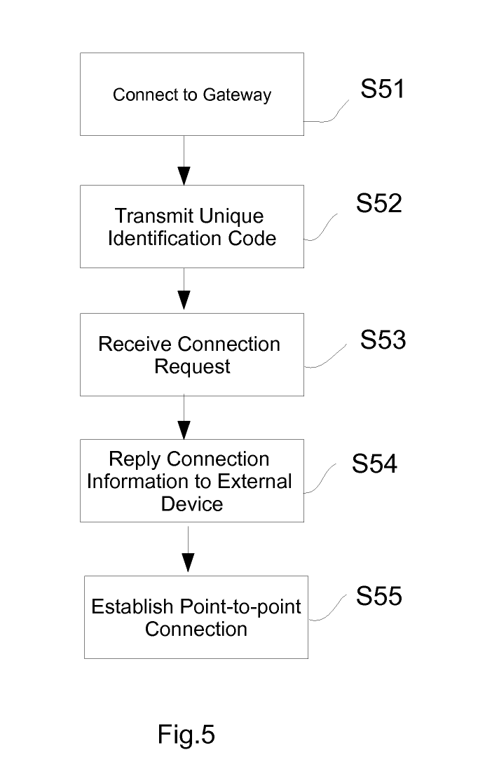

FIG. 5 is a point-to-point connection method according to the embodiment of the present invention. Firstly, the point-to-point apparatus like a heartbeat detector connects to a gateway like a mobile phone (step S51) via a non-TCP/IP network like a Bluetooth network. The gateway connects to a server with a second network of TCP/IP network to transmit the unique identification code of the point-to-point apparatus to the server (step S52). The server receives query request of the unique identification code (step S53) and the server responds connection information of a gateway that connects to the point-to-point apparatus with the unique identification code (step S54). The gateway helps to establishes the point-to-point connection between the point-to-point apparatus and the external device (step S55). Non-TCP/IP network may refer to various wire or wireless data transmission channels like Bluetooth, NFC, ZigBee, USB, ANT or other communication protocols. These point-to-point apparatuses do not have TCP/IP communication circuits due to cost or power consumption consideration and therefore cannot use TCP/IP like Wi-Fi to connect to a TCP/IP network or have their own fixed or floating IP address.

More detailed connection flows for connection problems under NATs may be found in documents related to hole punching, like UDP hole punching, TCP hole punching, ICMP hole punching, Session Traversal Utilities for NAT, Traversal Using Relay NAT, NAT-T Negotiation of NAT-Traversal in the IKE, Teredo tunneling using NAT traversal, Session Border Controller, RSIP, Middlebox Communication (MIDOCM), SOCKS, NAT PMP, UPnP, IGD and Application Gateway.

Please be noted that the mobile phone 22, the heartbeat detector 231 and the blood pressure detector 232 are used only examples not to limit the scope of the invention. More and more devices are developed in popular Internet of Things and point-to-point connection may help different application. For example, the mobile phone 22 may use point-to-point connection to watch video content captured by a IP camera. Other devices like a watch, a tablet computer, a wearable device, a wearable eye-glasses, sensors for collecting various signals and robots may be designed under the same invention idea to achieve the technical effect as mentioned above.

In an embodiment, except the public address or private address, each point-to-point apparatus has an unique identification code. Such unique identification code may be assigned by a server like the server 21 mentioned above, or set by manufacturers of these point-to-point apparatuses for performing point-to-point connection. These unique identification codes may further be integrated with user information and a server maintains and manages a database for unique identification codes and corresponding user information. With such, an external device may query all electronic devices registered to a user or a device list authorized to be accessed by the user. Such scheme may be integrated to one or more embodiments as mentioned above.

The server 21 is implemented by installing corresponding software on a machine to achieve the point-to-point service for the point-to-point terminal devices as mentioned above. The server 21 may also be implemented by software modules and be executed in multiple machines or be implemented as an application program executed on a cloud environment provided by a cloud service provider.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A point-to-point apparatus, comprising:
a device resource;
a processor for processing the device resource;
a storage for storing a first unique identification code; and
a network interface connecting to a first gateway via a first network and submitting the first unique identification code to a server via a second network, wherein an external device queries the server with the first unique identification code to find the first gateway associated to the point-to-point apparatus and accesses the device resource via the first gateway;
wherein the second network is a TCP/IP network and the first network is a non-TCP/IP network.

2. The point-to-point apparatus of claim 1, wherein the point-to-point apparatus selectively connects to a second gateway, when the point-to-point apparatus connects to the second gateway, the point-to-point apparatus submits the first unique identification code to the server via the second gateway so that the external device accesses the device resource of the point-to-point apparatus via the server.

3. The point-to-point apparatus of claim 1, wherein the first gateway has a second unique identification code, and the external device queries the server with the second unique identification code to establish a point-to-point connection with the point-to-point apparatus.

4. The point-to-point apparatus of claim 1, wherein the first gateway is a mobile phone, a tablet computer, a smart watch, a computer, a router or a television box.

5. The point-to-point apparatus of claim 1, wherein the device resource comprises a bio-information sensor or an environment sensor.

6. A method for establishing a point-to-point connection used over a wireless network system, the wireless network system comprising a gateway, a server and a point-to-point apparatus with an unique identification code, the method comprising:
the point-to-point apparatus connecting the gateway via a first network;
the gateway transmitting the unique identification code of the point-to-point apparatus to the server via a second network;
the server receiving a request for querying the unique identification code from an external device and replying the gateway connected to the point-to-point apparatus with the unique identification code; and
establishing a point-to-point connection between the point-to-point apparatus and the external device with the server;
wherein the first network is a non-TCP/IP network and the second network is a TCP/IP network.

7. The method of claim 6, wherein the server comprises a main server and a plurality of point-to-point servers, and the method further comprises:
the point-to-point device periodically registering the unique identification code to the main server via the gateway;
the main server assigning a service point-to-point server from the plurality of point-to-point servers;
when the external device requesting the main server to access the point-to-point apparatus associated to the unique identification code, the main server informs the external device to request service to the assigned service point-to-point server; and
the service point-to-point server assisting the external device to establish a point-to-point connection with the gateway.

8. The method of claim 6, wherein the gateway is a mobile phone, a tablet computer, a smart watch, a computer, a router or a television box.

9. The method of claim 6, wherein the point-to-point apparatus comprises a bio-information sensor or an environment sensor.

10. A method for establishing a point-to-point connection, comprising:
providing an unique identification code to be installed in a point-to-point apparatus that has a device resource;
when an external device requesting connection to the point-to-point apparatus with the unique identification code, a server being used for finding a gateway connected to the point-to-point apparatus and for assisting establishment of a point-to-point connection between the gateway and the external device for the external device to access the device resource;
wherein the point-to-point device and the gateway are connected via a first network, the gateway and the server are connected via a second network, the second network is a TCP/IP network and the first network is a non-TCP/IP network.

11. The method of claim 10, further comprising:
providing a first process to be installed in the gateway for processing communication between the point-to-point apparatus and the server; and
providing a second process to be installed in the point-to-point apparatus to process the communication between the server and the gateway.
